(19) United States
(12) Patent Application Publication
(10) Pub. No.: US 2016/0127827 A1
(43) Pub. Date: May 5, 2016

(54) SYSTEMS AND METHODS FOR SELECTING AUDIO FILTERING SCHEMES

(71) Applicant: GM GLOBAL TECHNOLOGY OPERATIONS LLC, Detroit, MI (US)

(72) Inventors: ELI TZIRKEL-HANCOCK, RA'ANANA (IL); OMER TSIMHONI, RAMAT HASHARON (IL)

(21) Appl. No.: 14/527,375

(22) Filed: Oct. 29, 2014

(51) Int. Cl. H04R 3/00; H04R 1/08

(52) U.S. Cl. CPC H04R 3/002; H04R 1/08; H04R 2499/13

(57) ABSTRACT

Methods and apparatus are provided for filtering sound in a vehicle. The methods includes generating a microphone signal corresponding to sounds in the passenger compartment. The methods also include receiving an audio-based service being utilized by at least one occupant. A sound separation mode is selected from the plurality of sound separation modes. Each sound separation mode corresponds to a different audio filtering scheme. The method also includes filtering the input received by the microphone in accordance with the selected sound separation mode to generate at least one filtered signal.

### TECHNICAL FIELD

The technical field generally relates to audio filtering, and more particularly relates to determining an audio filtering scheme to employ.

### BACKGROUND

Modern vehicles routinely include entertainment systems and interface with mobile devices (e.g., cellular phones, smart phones, etc.) and other systems to enhance the travel experience and provide ease of operation. These vehicles may utilize microphones to receive commands from the occupants of the vehicle and/or pass audio signals to cellular networks. These vehicles may also include one or more loudspeakers to play speech from an external source (e.g. mobile devices, automatic speech recognition agents) as well as music and other audible sources.

However, it is often the case that various undesired noises and/or overlapping speech patterns can cause problems for audio interfaces. In one example, a driver of a vehicle may be trying to have a phone conversation, but unwanted noises (e.g., children, music, or other conversations) are present, which interfere with the conversation. In another example, numerous occupants may be having a telephone conversation with a single party. In a further example, two occupants may be having separate telephone conversations with different parties. In yet another example, several occupants may be utilizing an automatic speech recognition (“ASR”) agent together to find a restaurant.

The speech of each occupant may comprise an interference in one scenario and/or a desirable condition in another. Similarly, the loudspeaker audio may be considered desirable in one scenario or interference in another. Accordingly, it is desirable to provide a system and method to filter sound in a passenger compartment of a vehicle. However, merely filtering sound using a single technique will not address the multitude of different speech situations that may occur. Therefore, in addition, it is desirable to determine which speech filtering technique should be applied for the given situation. Other desirable features and characteristics of the present invention will become apparent from the subsequent detailed description and the appended claims, taken in conjunction with the accompanying drawings and the foregoing technical field and background.

### SUMMARY

A method is provided for filtering sound in a compartment. In one embodiment, the method includes generating a microphone signal corresponding to sounds in the compartment received by at least one microphone. The method also includes receiving a type of audio-based service being utilized by the at least one occupant. The method further includes selecting a sound separation mode from the plurality of sound separation modes. Each sound separation mode corresponds to a different audio filtering scheme. The method also includes filtering the input received by the microphone in accordance with the selected sound separation mode to generate at least one filtered signal.

A system is provided for filtering sound in a compartment. In one embodiment, the system includes at least one microphone. The at least one microphone is configured to receive sounds in the compartment and provide a microphone signal corresponding to the received sounds. The system also includes a first signal processor in communication with the at least one microphone and configured to receive an input from the at least one microphone. A memory stores a plurality of sound separation modes wherein each sound separation mode corresponds to a different audio filtering scheme. The memory also stores contextual data associating with at least one of the plurality of sound separation modes. The memory also stores a mode association table storing a probability of the stored contextual data being associated with at least one of the sound separation modes. The system further includes a controller in communication with the first signal processor and the memory. The controller is configured to select a sound separation mode from a plurality of sound separation modes. The first signal processor is further configured to filter the input received by the microphone in accordance with the selected sound separation mode to generate at least one filtered signal.

### DESCRIPTION OF THE DRAWINGS

The exemplary embodiments will hereinafter be described in conjunction with the following drawing figures, wherein like numerals denote like elements, and wherein:

FIG. 1 is a block diagram of a system for filtering sound in accordance with various embodiments;

FIG. 2 is block diagram of a vehicle utilizing the system of FIG. 1 in accordance with various embodiments; and

FIG. 3 is a flowchart showing a method of filtering sound in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

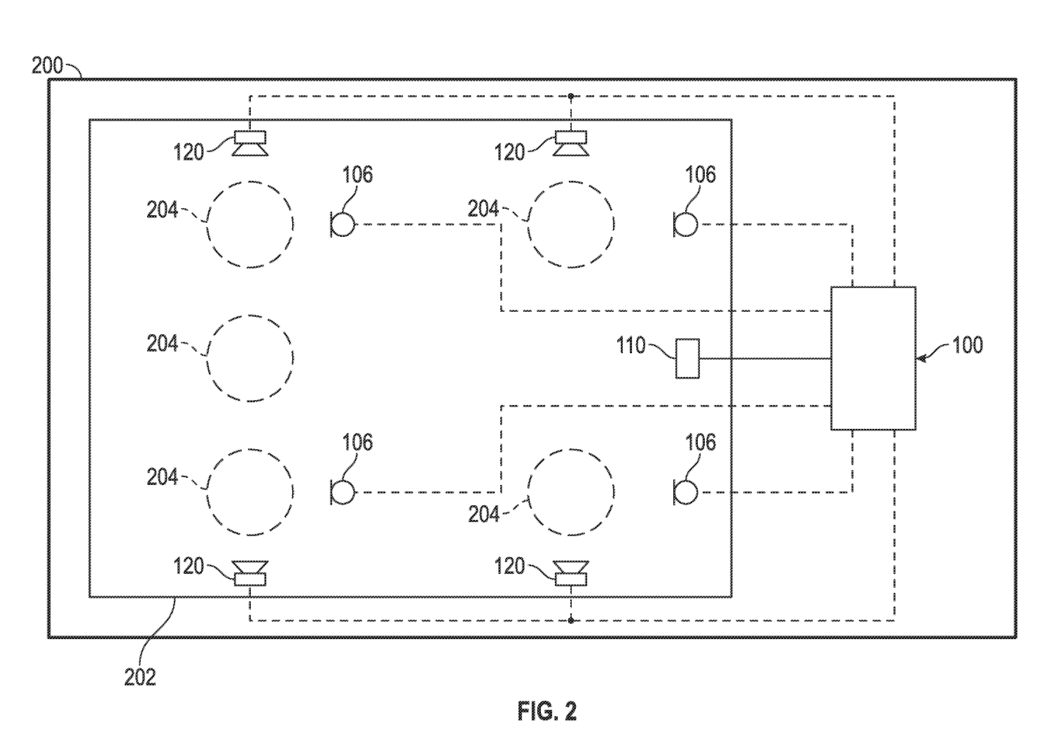

Referring to the figures, wherein like numerals indicate like parts throughout the several views, a system 100 and method 300 of filtering sound is shown and described herein. In the embodiment shown in FIG. 2, the system 100 and method 300 may be implemented in a vehicle 200, to filter sound in a compartment 202, e.g., a passenger compartment 202. The vehicle 200 in the exemplary embodiment is an automobile (not numbered). However, it should be appreciated that the system 100 and method 300 may be applied to other types of vehicles 200, including, but not limited to, aircraft and watercraft. Furthermore, the system 100 and method 300 may be implemented in non-vehicle applications, e.g., an office environment.

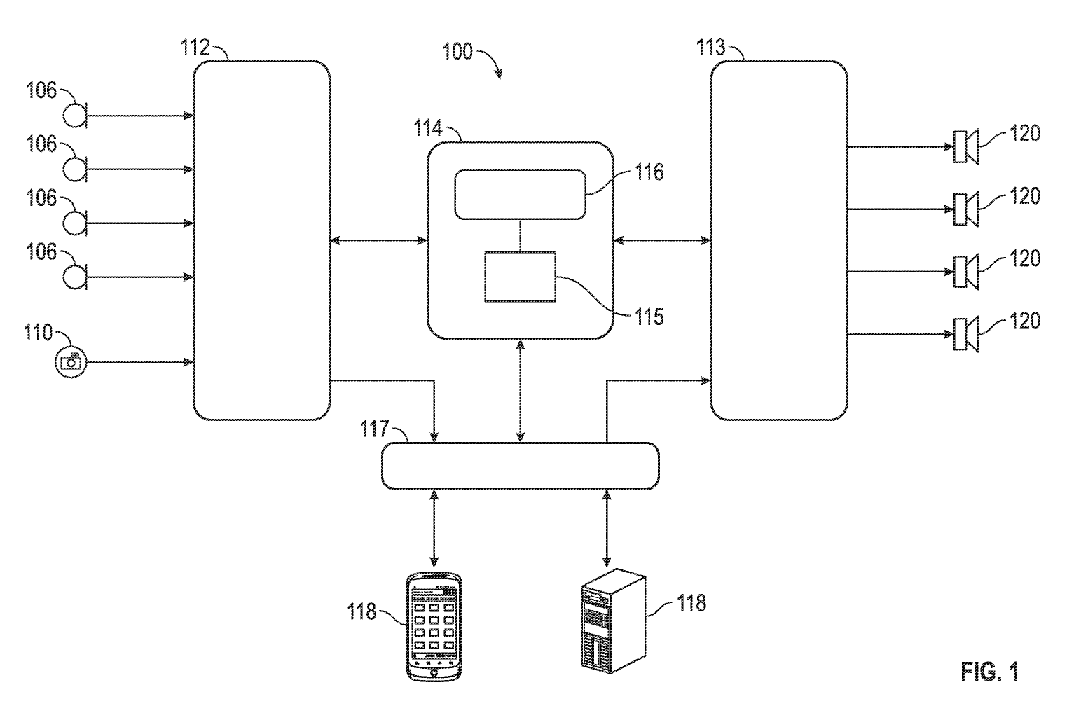

Referring now to FIG. 1, the system 100 includes at least one microphone 106. In the exemplary embodiment, the system 100 includes a plurality of microphones 106. However, it should be appreciated that in other embodiments, a single microphone 106 may be implemented. The microphones 106 are configured to receive acoustic sound present in the passenger compartment 202, as shown in FIG. 2. With brief reference to FIG. 2, these sounds may include, but are not limited to, speech of the occupants 204, music, and other noises. The microphones 106 each generate an electric microphone signal corresponding to the received sounds. That is, each microphone 106 is an acoustic-to-electrical transducer, as is appreciated by those skilled in the art.

The system 100 may also include a camera 110, as shown in FIGS. 1 and 2. The camera 110 is configured to obtain images of the passenger compartment 202 of the vehicle 200. Of course, in another embodiment, the system 100 may include multiple cameras 110. The images are transmitted via a video signal. As explained in further detail below, the camera 110 may be utilized for multiple purposes, including, but not limited to, determining the presence, location, and/or identity of one or more occupants 204 of the passenger compartment 202. The camera 110 may also be utilized to detect activity of the occupants 204, e.g., gestures, motions, or other movements of the occupants 204. However, in other embodiments, the system 100 may be implemented without the camera 110, or with other devices. For instance, ultrasound detectors, short range radar, pressure sensors, and other sensing devices may be utilized to determine the presence, location, and/or gestures of the occupants 204.

The system 100 also includes at least one signal processor 112, 113. In the exemplary embodiment shown in FIG. 1, the system 100 includes a first signal processor 112 and a second signal processor 113. The signal processors 112, 113 of the exemplary embodiments are implemented with microprocessor-based devices configured to execute instructions and perform calculations for processing digital signals. While FIG. 1 shows the first and second signal processors 112, 113 as separate, distinct devices, it should be appreciated that the first and second signal processors 112, 113 may be implemented together as a single device and/or integrated with other devices.

The first signal processor 112 of the exemplary embodiment is in communication with the microphones 106 and the camera 110. As such, the first signal processor 112 is configured to receive inputs from each microphone 106 and the camera 110. Specifically, the first signal processor 112 receives audio signals corresponding to the sounds received by the microphones 106 and at least one video signal corresponding to the images obtained by the camera 110.

The first signal processor 112 of the exemplary embodiment may be configured to apply any of several signal and/or image processing schemes to the audio and/or video signals. In the case of audio signals, these schemes include, but are not limited to, acoustic echo cancellation (“AEC”), acoustic echo suppression (“AES”), noise reduction, voice activity detection (“VAD”), beamforming, spatial filtering, and signal separation (“SSEP”).

The system 100 also includes a controller 114. The controller 114 of the exemplary embodiment includes a microprocessor 115 capable of executing instructions (e.g., running a program) and/or performing calculations, as is appreciated by those skilled in the art. The controller 114 of the exemplary embodiment also includes a memory 116 in communication with the microprocessor and capable of storing data. The memory 116 may be implemented with a semiconductor-based device (e.g., RAM, ROM, Flash), optical storage (e.g., CD, DVD), magnetic-based device (e.g., a hard disk drive), and/or other devices known to those skilled in the art.

The controller 114 of the exemplary embodiment is in communication with the first signal processor 112. This communication may be achieved by electrical connection, optical signals, radio signals, or other techniques known to those skilled in the art. As such, the controller 114 may process data relating to the audio signals produced by the microphones 106 and the at least one video signal of the camera 110. Although FIG. 1 shows the controller 114 and the signal processors 112, 113 as separate devices, it should be appreciated that the controller 114 and the signal processors 112, 113 may be implemented together as a single device and/or integrated with other devices.

The controller 114 may also be configured to determine a presence of at least one occupant 204 of the passenger compartment 202. In the exemplary embodiment, the controller 114 utilizes signals from the microphones 106 and the camera 110 to determine the presence of the occupants 204. In one example, the images obtained by the camera 110 may be utilized to determine the presence, location, and/or identity of occupants 204 in the passenger compartment 202. Furthermore, audio signals, including different signal strengths of the audio signals, may be utilized to determine the presence, location, and/or identity of the occupants 204. However, it should be appreciated that the presence, location, and/or identity of the occupants 204 may be ascertained using other techniques. For example, pressure sensors (not shown) may be utilized to determine the presence and/or location of the occupants 204. Furthermore, an occupant 204 could identify him or herself such that the identity of the occupant 204 is ascertained. In one instance, possession of a particular key fob may be utilized to identify the occupant 204. In another instance, selecting a certain seat configuration may be utilized to identify the occupant 204.

The controller 114 is also configured to calculate a probability of whether each occupant 204 of the passenger compartment 202 is participating or interfering in a conversation or other use of speech. The controller 114 may utilize these probabilities to determine whether each occupant 204 is participating or interfering. This process is dynamic, i.e., it is typically not known prior to a conversation begins whether the occupants 204 are participating or interfering.

Numerous procedures may be utilized to determine whether the occupants 204 are participating or interfering. For instance, the speech patterns of multiple occupants 204 may be analyzed to determine if they are interleaving, i.e., speaking at the same time, or collaborating, i.e., taking turns in speaking As such, an interleaving speech pattern tends to indicate that the occupants 204 are interfering with one another in a specific conversation while a collaborating speech pattern tends to indicate that the occupants 204 are participating with one another in the specific conversation. In another instance, head, mouth, and hand movements perceived by the camera 110 may be utilized in the determination.

It should be appreciated that calculating the probability of participating or interfering need not be an instantaneous process. The controller 114 may collect multiple pieces of evidence to perform the probability calculation and the subsequent determination.

The system 100 further includes an interface 117 for providing communications with at least one audio-based service 118. The audio-based service 118 might include, for example, a cellular telephone (not separately numbered) and an automatic speech recognition (“ASR”) agent (not separately numbered). The ASR agent may be part of a navigation service, a venue finding service, etc. The ASR agent may be a feature of vehicle-integrated service, e.g., On-Star®, as is offered by General Motors Company of Detroit, Mich. Of course, other audio-based services 118 may be implemented as appreciated by those skilled in the art.

In the exemplary embodiment, as shown in FIG. 1, the interface 117 provides communications between the first signal processor 112 and the audio-based service 118. The interface 117 also provides communications between the controller 114 and the audio-based service 118. Further, the interface 117 provides communications between the audio-based service 118 and the second signal processor 113. The interface 117 of the exemplary embodiment may be implemented with any suitable hardware and/or software to allow communication between the signal processors 112, 113 and at least one audio-based service 118.

The second signal processor 113 of the exemplary embodiment is in communication with the controller 114 and the interface 117. As such, the second signal processor 113 may receive signals from the controller 114 and/or the interface 117. The second signal processor 113 is electrically connected to at least one speaker 120. In the exemplary embodiment, a plurality of speakers 120 are integrated with the vehicle 200 and in communication with the second signal processor 113, as is shown in FIG. 2, and is well known to those skilled in the art.

The second signal processor 113, working in conjunction with the controller 114 and the interface 117, may selectively condition and send audio signals to the various speakers 120. For example, the second signal processor 113 may deliver music-based audio signals to speakers 120 in the rear of the passenger compartment 202, while relaying audio signals related to a telephone conversation to speakers 120 in the front of the passenger compartment 202.

In the exemplary embodiment, the memory 116 stores a plurality of sound separation modes. That is, instructions, equations, and other relevant information necessary to implement each sound separation mode are stored in the memory 116 for use by the microprocessor 115 and/or the signal processors 112, 113. Each sound separation mode corresponds to a different audio filtering scheme or technique, as described in greater detail below.

In the exemplary embodiment, four distinct sound separation modes are defined. A first sound separation mode may be referred to as a “one on one” mode (“1o1”) or a “private” mode. In this first sound separation mode, disturbances between one occupant 204 and other occupants 204 are reduced such that the speech of the one occupant 204 is retained while the speech of the other occupants 204 and other sounds are reduced, masked, or otherwise eliminated. Said another way, in the first sound separation mode, the various audio signals received from the microphones 106 are combined, separated, filtered, and/or otherwise conditioned such that a resulting conditioned audio signal primarily comprises the speech of the one occupant 204.

One example of a use of the first sound separation mode is when one occupant 204, e.g., a driver of the vehicle 200, is attempting to have a business telephone conversation and other occupants 204, e.g., children, are talking to each other and interfering with the call.

A second sound separation mode may be referred to as an “N one on one” mode (“n1o1”). In this second sound separation mode, disturbances between one occupant 204 and another occupant 204 are reduced such that speech of each occupant 204 is isolated from one another and from other sounds. That is, in the second sound separation mode, the various audio signals received from the microphones 106 are combined, separated, filtered, and/or otherwise conditioned such that a resulting first conditioned audio signal primarily comprises the speech of the one occupant 204 and a second conditioned audio signal primarily comprises the speech of the another occupant 204.

One example of a use of the second sound separation mode is when one occupant 204, e.g., a passenger, is having a telephone conversation while another occupant 204, e.g., is using the ASR agent to find directions to a destination through navigation software.

A third sound separation mode may be referred to as a “many on one” mode (“Mo1”). In this third sound separation mode, disturbances between a plurality of occupants 204 and other occupants 204 are reduced such that the speech of the plurality of occupants 204 are combined with one another. Said another way, in the third sound separation mode, the various audio signals received from the microphones 106 are combined, separated, filtered, and/or otherwise conditioned such that a resulting filtered audio signal primarily comprises the speech of the plurality of occupants 204. One example of the use of third sound separation mode is when multiple occupants 204 share a telephone conversation (i.e., conferencing).

A fourth sound separation mode may be referred to as a “many on many” mode (“MoM”). This mode is similar to the second sound separation mode, except that in the fourth sound separation mode, two more signals are sent to the same audio service. For example, the fourth sound separation mode may be utilized where two occupants converse with the ASR agent to book a restaurant.

The various sound separation modes may utilize spatial filtering, e.g., beamforming, to separate the sounds and/or achieve source separation. That is, the microprocessor 115 and/or the signal processors 112, 113 may utilize spatial filtering and/or source separation. While implementing spatial filtering and blind source separation are known by those skilled in the art, it should be appreciated that these techniques may be enhanced to exploit vehicle acoustics and visual information. Other techniques for implementing the sound separation modes may also be utilized. For instance, instead of, or in addition to the spatial filtering techniques, one or more microphones near selected occupants may be selected to be utilized based on the selected sound separation mode.

The memory 116 is configured to store contextual data regarding the audio-based services utilized by the occupants 204. More specifically, the contextual data associates the audio-based services being utilized, the caller ID of a caller, the presence and location of the occupants 204, and/or other contextual information with the various sound separation modes. For example, the contextual data stored in the memory 116 may associate the first sound separation mode with a phone call via a particular number, e.g., a co-worker, is received. In another example, the contextual data may associate the third sound separation mode when certain occupants are identified and the ASR agent is being utilized.

The memory 116 may also be configured to store a mode association table. The mode association table stores a probability of the stored contextual data being associated with at least one of the sound separation modes.

The controller 114 is configured to select a sound separation mode from the plurality of sound separation modes. In one example, the controller 114 is configured to select the sound separation mode based at least in part on mode determination data received by the controller 114. The mode determination data may include, but is not limited to, the contextual data, the mode association table, speech patterns of the occupants, gestures by the occupants, and movement by the occupants.

As such, the controller 114 utilizes the contextual data stored in the memory 116, the mode association table, and/or other received data to determine which sound separation mode is most applicable to the current situation. For example, when a phone call is received from a co-worker of the occupant 204, the first sound separation mode may be selected to filter out noises and other disturbances from other occupants, e.g., children talking in the back seat of the vehicle 200.

The controller 114 may also utilize a pattern of voice-overlap in the speech of the plurality of occupants 204 to select the sound separation mode. For example, significant overlap indicates that occupants are interfering with one another. As such, the first sound separation mode may be more likely than other sound separation modes, depending on the particular context.

It should be appreciated that the selection of a sound separation mode is not a permanent condition. Automatic selection and/or reselection of the sound separation mode may be performed by the controller 114 at any time. For example, a different sound separation mode may be selected when a distinct conversation is begun. As another example, a different sound separation mode may be selected when another occupant 204 joins and/or exits the conversation.

Manual selection of the sound separation mode may also be achieved. For instance, an occupant may manually select the sound separation mode using a pushbutton, touchscreen, etc. Manual selection of the sound separation mode may also be achieved by speaking certain words and/or phrases or by certain movements and/or gestures.

In the exemplary embodiment, the first signal processor 112 is configured to filter the input received by the microphones 106 in accordance with the selected sound separation mode to generate at least one filtered signal. That is, the first signal processor 112 is configured to apply the selected sound separation scheme to filter the audio signals produced by the microphones 106, and produce at least one filtered signal.

As the first signal processor 112 is in communication with the interface 117, the at least one filtered signal may be sent to the interface 117, such that the at least one signal may then be conveyed to the audio-based service 118, e.g., the phone or the ASR agent. As such, when the controller 114 selects the first sound separation mode, the first signal processor 112 filters the audio signals accordingly, and the audio-based service 118 receives a filtered signal corresponding generally to only the speech of the one occupant 204.

The various contextual data associating the audio-based service 118 to the occupant may be modified and/or replaced. That is, the controller 114 may change the contextual data over time. The changed or modified contextual data is then stored in the memory 116. In one technique, images obtained by the camera 110 may also be utilized to interpret gestures and other movements by occupants 204 of the vehicle 200. For example, when a business call is received, one occupant 204 may move his or her hand in a fashion to quiet down other occupants 204, e.g., children. The controller 114 may interpret these gestures as the occupant 204 requiring the first sound separation mode, and thus modify the contextual data associated with the identity of the occupant 204 and the particular phone number, or increase the corresponding probability in the mode association table. Modifying the stored contextual data may be done in response to the selection of the sound separation mode. For example, a probability of selecting the first sound separation mode may be increased based on the caller ID of a present call received by the system 100.

Selection of the sound separation mode from the plurality of sound separation modes may be influenced by factors other than the stored contextual data. For instance, an occupant 204 may select a particular mode via a selection with buttons, voice commands, and/or other input techniques. As just one example, when the occupant 204 places a business call, he may say the word “private”. The controller 114, via the first signal processor 112, recognizes this word and selects the first sound separation mode. The controller 114 may also modify the contextual data associated with the identity of the occupant 204 and the particular phone number, such that the command need not be given next time that number is called by that particular occupant 204.

In the exemplary embodiment, the second signal processor 113 is configured to regulate operation of the speakers 120. The regulation of the speakers 120 may be based on the selected sound separation mode, the audio-based service(s) 118 being utilized, the location of the occupants 204, the contextual data, and/or other considerations. As such, signals sent to certain speakers 120 may be modified, reduced, or eliminated by the second signal processor 113.

As just one example, when one occupant 204 is engaging in a telephone call, e.g., with the first sound selection mode, the speaker 120 nearest that occupant 204 is utilized to project the sounds from the other party, while other speakers 120 are utilized to play music, e.g., to backseat occupants 204.

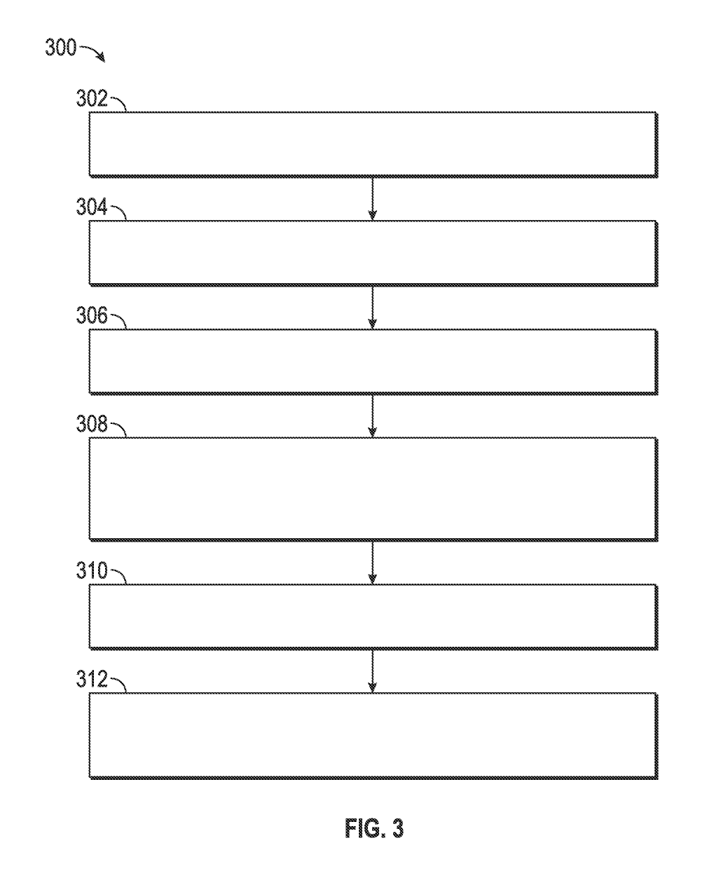

Referring now to FIG. 3, the method 300 of filtering sound in a passenger compartment 202 of a vehicle 200 is described. It should be noted that the method may be practiced outside of the particular system 100 described above. As can be appreciated in light of the disclosure, the order of operation within the method is not limited to the sequential execution as illustrated in FIG. 3, but may be performed in one or more varying orders as applicable and in accordance with the present disclosure. In various embodiments, the method 300 can be scheduled to run based on predetermined events, and/or can run continually during operation of the vehicle 200.

The method 300 includes, at 302, generating a microphone signal corresponding to sounds in the passenger compartment 202 received by at least one microphone 106. The method 300 further includes, at 304, receiving a type of audio-based service 118 being utilized by the at least one occupant. For example, an identification of the audio-based service 118 being utilized may be received by the controller 114 from that service 118.

The method 300 may also include, at 306, receiving mode determination data. Continuing, the method 300 includes, at 308, selecting a sound separation mode from the plurality of sound separation modes, wherein each sound separation mode corresponds to a different audio filtering scheme. Selecting the sound separation mode may be based at least partially on the mode determination data. Once selection of the sound separation mode is made, the method 300 continues, at 310, by filtering the input received by the microphone in accordance with the selected sound separation mode to generate at least one filtered signal. The method 300 may also include, at 312, rendering the signal received from the audio-based service to a loudspeaker in accordance with the selected sound separation mode.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of filtering sound in a compartment, comprising:
generating a microphone signal corresponding to sounds in the compartment received by at least one microphone;
receiving a type of audio-based service being utilized by at least one occupant of the compartment;
selecting a sound separation mode from the plurality of sound separation modes, wherein each sound separation mode corresponds to a different audio filtering scheme; and
filtering the input received by the microphone in accordance with the selected sound separation mode to generate at least one filtered signal.

2. The method as set forth in claim 1, further comprising receiving mode determination data and wherein selecting a sound separation mode is further defined as selecting a sound separation mode based at least partially on the mode determination data.

3. The method as set forth in claim 2, wherein the mode determination data comprises a mode association table storing a probability of the sound separation modes being associated with contextual data.

4. The method as set forth in in claim 3 wherein the contextual data includes at least one of caller identification information, a location of a speaking occupant in the compartment, and the type of the audio-based service being utilized.

5. The method as set forth in claim 2, further comprising receiving a video signal from a camera and wherein the mode determination data comprises at least one of stored contextual data, the microphone signal, and the video signal.

6. The method as set forth in claim 5, further comprising interpreting a gesture of an occupant of the vehicle from the video signal and wherein selecting the sound separation mode is further defined as selecting the sound separation mode based at least partially on the gesture of the occupant.

7. The method as set forth in claim 2, further comprising modifying the contextual data in response to the selection of the sound separation mode.

8. The method as set forth in claim 1, wherein selecting a sound separation mode from the plurality of sound separation modes comprises selecting a sound separation mode based at least partially on a pattern of voice-overlap in the speech of a plurality of occupants.

9. The method as set forth in claim 1, wherein selecting a sound separation modes comprises selecting a first sound separation mode in which speech from all occupants except one occupant are reduced.

10. The method as set forth in claim 1,
wherein providing a plurality of sound separation modes comprises providing a second sound separation mode in which the speech of at least two occupants are isolated from one another; and
wherein filtering the input received by the at least one microphone comprises filtering the input received from the at least one microphone in accordance with the second sound separation mode to generate a first filtered signal corresponding to the speech of a first occupant and a second filtered signal corresponding to the speech of a second occupant.

11. The method as set forth in claim 1,
wherein providing a plurality of sound separation modes comprises providing a third sound separation mode in which the speech of at least two occupants are combined with one another; and
wherein filtering the input received by the at least one microphone comprises filtering the input received from the at least one microphone in accordance with the third sound separation mode to generate a filtered signal corresponding to the combined speech of a plurality of occupants.

12. The method as set forth in claim 1, wherein selecting a sound separation mode is further defined as selecting the sound separation mode based on a selection by an occupant.

13. The method as set forth in claim 1, further comprising rendering the signal received from the audio-based service to a loudspeaker.

14. The method as set forth in claim 13, wherein rendering the signal received from the audio-based service is further defined as rendering the signal received from the audio-based service in accordance with the selected sound separation mode.

15. The method as set forth in claim 1, further comprising sending the at least one filtered signal to an interface for relay to the audio-based service.

16. A system for filtering sound in a compartment, comprising:
at least one microphone configured to receive sounds in the compartment and provide a microphone signal corresponding to the received sounds;
a first signal processor in communication with said at least one microphone and configured to receive an input from said at least one microphone;
a memory storing
a plurality of sound separation modes wherein each sound separation mode corresponds to a different audio filtering scheme,
contextual data associated with at least one of the plurality of sound separation modes, and
a mode association table storing a probability of the stored contextual data being associated with at least one of the sound separation modes; and
a controller in communication with said first signal processor and said memory and configured to select a sound separation mode from a plurality of sound separation modes;
wherein said first signal processor is further configured to filter the input received by the microphone in accordance with the selected sound separation mode to generate at least one filtered signal.

17. The system as set forth in claim 16, further comprising a loudspeaker for rendering a signal received from the audio-based service to a loudspeaker in accordance with the selected sound separation mode.

18. A vehicle, comprising:
a passenger compartment;
at least one microphone configured to receive sounds in the passenger compartment and provide a microphone signal corresponding to the received sounds;
a first signal processor in communication with said microphone and configured to receive an input from said at least one microphone;
a memory storing
a plurality of sound separation modes wherein each sound separation mode corresponds to a different audio filtering scheme,
contextual data associated with at least one of the plurality of sound separation modes, and
mode association table storing a probability of the stored contextual data being associated with at least one of the sound separation modes; and
a controller in communication with said first signal processor and said memory and configured to select a sound separation mode;
wherein said first signal processor is further configured to filter the input received by the microphone in accordance with the selected sound separation mode to generate at least one filtered signal.

19. The vehicle as set forth in claim 18, further comprising a loudspeaker for rendering a signal received from the audio-based service to a loudspeaker in accordance with the selected sound separation mode.
